(19) United States
(12) Patent Application Publication
(10) Pub. No.: US 2023/0196794 A1
(43) Pub. Date: Jun. 22, 2023

(54) SYSTEM AND METHOD TO CORRECT OVERSATURATION FOR IMAGE-BASED SEATBELT DETECTION

(71) Applicant: VEONEER US, INC., Southfield, MI (US)

(72) Inventors: Caroline Chung, Southfield, MI (US); Mitchell Pleune, Southfield, MI (US); Afrah Naik, Southfield, MI (US)

(73) Assignee: VEONEER US, INC., Southfield, MI (US)

(21) Appl. No.: 17/556,278

(22) Filed: Dec. 20, 2021

(51) Int. Cl. G06V 20/59; G06T 7/70; H04N 5/243; G06V 10/25; G06V 10/28; G06V 10/30

(52) U.S. Cl. CPC G06V 20/59; G06T 7/70; H04N 5/243; G06V 10/25; G06V 10/28; G06V 10/30; G06T 2207/30196; G06T 2207/30268; G06T 2207/10048

(57) ABSTRACT

A system and method for detecting seatbelt positioning includes capturing, by a camera, a near infrared source image of an occupant in a vehicle, determining a position of a head of the occupant in the source image, determining a region of interest for a seatbelt based on the position of the head; determining an oversaturation condition in the region of interest for the seatbelt, adjusting the source image to form an adjusted image compensating the oversaturation condition in the region of interest for the seatbelt, converting the adjusted image to a black-and-white image, and detecting the seatbelt within the black-and-white image. Adjusting the source image to compensate the oversaturation condition may include adjusting an exposure level of the source image based on a contrast ratio in the region of interest and/or based on detecting a predetermined pattern of the seatbelt within the region of interest for the seatbelt.

### BACKGROUND

### 1. Field of the Invention

The present invention generally relates systems and methods for detecting a seatbelt having a known pattern using an image having an oversaturated condition.

### 2. Description of Related Art

Cameras and other image detection devices have been utilized to detect one or more objects. Control systems that are in communication with these cameras can receive images captured by the cameras and process these images. The processing of these images can include detecting one or more objects found in the captured images. Based on these detected objects, the control system may perform some type of action in response to these detected variables.

Conventional systems for detecting seatbelt usage typically rely upon a seat belt buckle switch. However, those conventional systems are unable to detect if the seatbelt is properly positioned or if the seat belt buckle is being spoofed. Seat track sensors are typically used to determine distance to an occupant of a motor vehicle. However, such use of seat track sensors do not account for body position of the occupant relative to the seat.

Image-based systems may have difficulty detecting objects when one or more regions of an image are oversaturated, which can result from bright light, such as direct sunlight.

### SUMMARY

A method for detecting seatbelt positioning is provided. The method comprises: capturing, by a camera, a source image of an occupant in a vehicle; determining a position of a head of the occupant in the source image; determining a region of interest for a seatbelt based on the position of the head of the occupant; determining an oversaturation condition in the region of interest for the seatbelt; adjusting the source image to form an adjusted image compensating the oversaturation condition in the region of interest for the seatbelt; converting the adjusted image to a black-and-white image; and detecting the seatbelt within the black-and-white image.

A system for detecting seatbelt positioning is provided. The system comprises: a seatbelt having a predetermined pattern; a camera configured to capture a source image of an occupant wearing the seatbelt; and a controller in communication with the camera. The controller is configured to: determine a position of a head of the occupant in the source image; determine a region of interest for the seatbelt based on the position of the head of the occupant; determine an oversaturation condition in the region of interest for the seatbelt; adjust the source image to form an adjusted image that compensates the oversaturation condition in the region of interest for the seatbelt; convert the adjusted image to a black-and-white image; and detect the seatbelt within the black-and-white image.

Further objects, features, and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 illustrates a vehicle having a system for detecting proper seatbelt usage and for detecting distance to the seatbelt;

FIG. 2 illustrates a forward looking view of a cabin of the vehicle having a system for detecting proper seatbelt usage and for detecting distance to the seatbelt;

FIG. 3 illustrates a block diagram of the system for detecting proper seatbelt usage and for detecting distance to the seatbelt;

FIG. 4 illustrates a first example of improper seatbelt positioning;

FIG. 5 illustrates a second example of improper seatbelt positioning;

FIG. 6 illustrates a third example of improper seatbelt positioning;

FIG. 7A shows a near infrared (NIR) image of a person wearing a seatbelt in accordance with an aspect of the present disclosure;

FIG. 7B shows a filtered image based on the NIR image of FIG. 7A, in accordance with the present disclosure;

FIG. 7C shows a Black/White image based on the NIR image of FIG. 7A, in accordance with the present disclosure;

FIG. 7D shows an image based on the NIR image of FIG. 7A, illustrating detection points, in accordance with the present disclosure;

FIG. 8 shows an image of an occupant wearing a seatbelt, and with an oversaturated region;

FIG. 9 shows the image of FIG. 8, with boxes indicating a position of a head of the occupant and a region of interest for the seatbelt;

FIG. 10 shows an adjusted image compensating the oversaturation condition in the region of interest for the seatbelt;

FIG. 11 shows a black-and-white image based on the adjusted image of FIG. 10; and

FIG. 12 shows a flowchart listing steps in a method of detecting seatbelt positioning.

### DETAILED DESCRIPTION

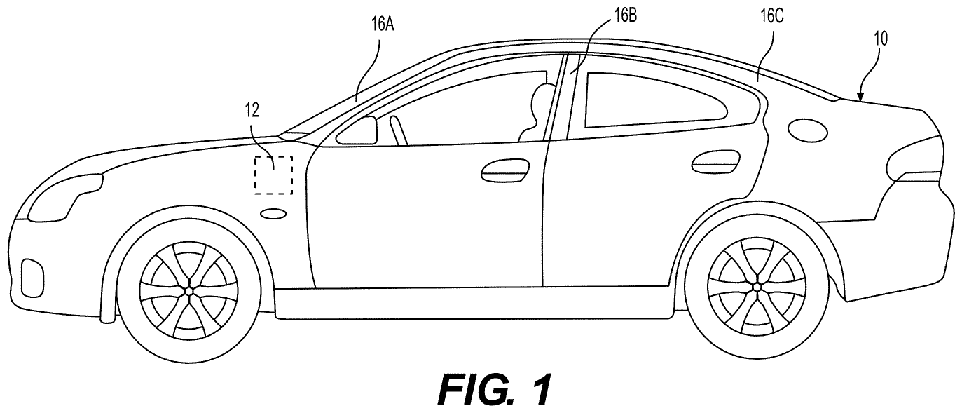

Referring to FIG. 1, illustrated is a vehicle 10 having a seatbelt detection system 12 for detecting proper seatbelt usage and/or for detecting distance to the seatbelt. In this example, the seatbelt detection system 12 has been incorporated within the vehicle 10. However, it should be understood that the seatbelt detection system 12 could be a standalone system separate from the vehicle 10. In some embodiments, the seatbelt detection system 12 may employ some or all components existing in the vehicle 10 for other systems and/or for other purposes, such as for driver monitoring in an advanced driver assistance system (ADAS). Thus, the seatbelt detection system 12 of the present disclosure may be implemented with very low additional costs.

As to the vehicle 10, the vehicle 10 is shown in FIG. 1 as a sedan type automobile. However, it should be understood that the vehicle 10 may be any type of vehicle capable of transporting persons or goods from one location to another. As such, the vehicle 10 could, in addition to being a sedan type automobile, could be a light truck, heavy-duty truck, tractor-trailer, tractor, mining vehicle, and the like. Also, it should be understood that the vehicle 10 is not limited to wheeled vehicles but could also include non-wheeled vehicles, such as aircraft and watercraft. Again, the term vehicle should be broadly understood to include any type of vehicle capable of transporting persons or goods from one location to another and it should not be limited to the specifically enumerated examples above.

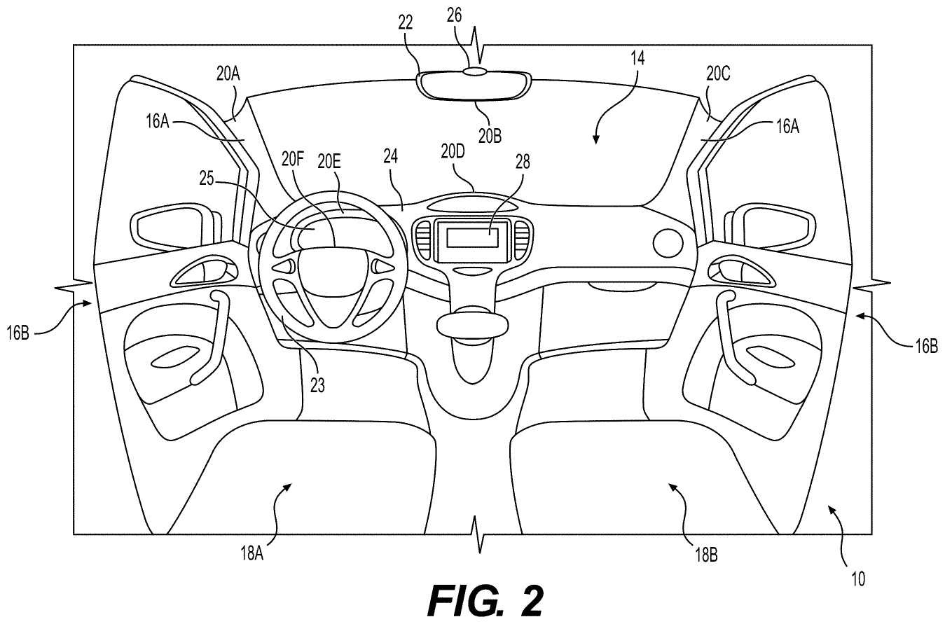

Referring to FIG. 2, a cabin 14 of the vehicle 10 is shown. As it is well understood in the art, the cabin 14 is essentially the interior of the vehicle 10 wherein occupants and/or goods are located when the vehicle is in motion. The cabin 14 of the vehicle may be defined by one or more pillars that structurally define the cabin 14. For example, in FIG. 2, A-pillars 16A and B-pillars 16B are shown. FIG. 1 further illustrates that there may be a third pillar or a C-pillar 16C. Of course, it should be understood that the vehicle 10 may contain any one of a number of pillars so as to define the cabin 14. Additionally, it should be understood that the vehicle 10 may be engineered so as to remove these pillars, essentially creating an open-air cabin 14 such as commonly found in automobiles with convertible tops.

Located within the cabin 14 are seats 18A and 18B. The seats 18A and 18B are such that they are configured so as to support an occupant of the vehicle 10. The vehicle 10 may have any number of seats. Furthermore, it should be understood that the vehicle 10 may not have any seats at all.

The vehicle 10 may have one or more cameras 20A-20F located and mounted to the vehicle 10 so as to be able to have a field a view of at least a portion of the cabin 14 that function as part of a vision system. As such, the cameras 20A-20F may have a field of view of the occupants seated in the seats 18A and/or 18B. Here, cameras 20A and 20C are located on the A-pillars 16A. Camera 20B is located on a rearview mirror 22. Camera 20D may be located on a dashboard 24 of the vehicle 10. Camera 20E and 20F may focus on the driver and/or occupant and may be located adjacent to the vehicle cluster 25 or a steering wheel 23, respectively. Of course, it should be understood that any one of a number of different cameras may be utilized. As such, it should be understood that only one camera may be utilized or numerous cameras may be utilized. Furthermore, the cameras 20A-20F may be located and mounted to the vehicle 10 anywhere so long as to have a view of at least a portion of the cabin 14.

The cameras 20A-20F may be any type of camera capable of capturing visual information. This visual information may be information within the visible spectrum, but could also be information outside of the visible spectrum, such as infrared or ultraviolet light. Here, the cameras 20A-20F are near infrared (NIR) cameras capable of capturing images generated by the reflection of near infrared light. Near infrared light may include any light in the near-infrared region of the electromagnetic spectrum (from 780 nm to 2500 nm). However, the seatbelt detection system 12 of the present disclosure may be configured to use a specific wavelength or range of wavelengths within the near-infrared region.

The source of this near-infrared light could be a natural source, such as the sun, but could also be an artificial source such as a near-infrared light source 26. The near-infrared light source 26 may be mounted anywhere within the cabin 14 of the vehicle 10 so as long as to be able to project near-infrared light into at least a portion of the cabin 14. Here, the near-infrared light source 26 is mounted to the rearview mirror 22 but should be understood that the near-infrared light source 26 may be mounted anywhere within the cabin 14. Additionally, it should be understood that while only one near-infrared light source 26 is shown, there may be more than one near-infrared light source 26 located within the cabin 14 of the vehicle 10.

Also located within the cabin 14 may be an output device 28 for relaying information to one or more occupants located within the cabin 14. Here, the output device 28 is shown in a display device so as to convey visual information to one or more occupants located within the cabin 14. However, it should be understood that the output device 28 could be any output device capable of providing information to one or more occupants located within the cabin 14. As such, for example, the output device may be an audio output device that provides audio information to one or more occupants located within the cabin 14 of a vehicle 10. Additionally, should be understood that the output device 28 could be a vehicle subsystem that controls the functionality of the vehicle.

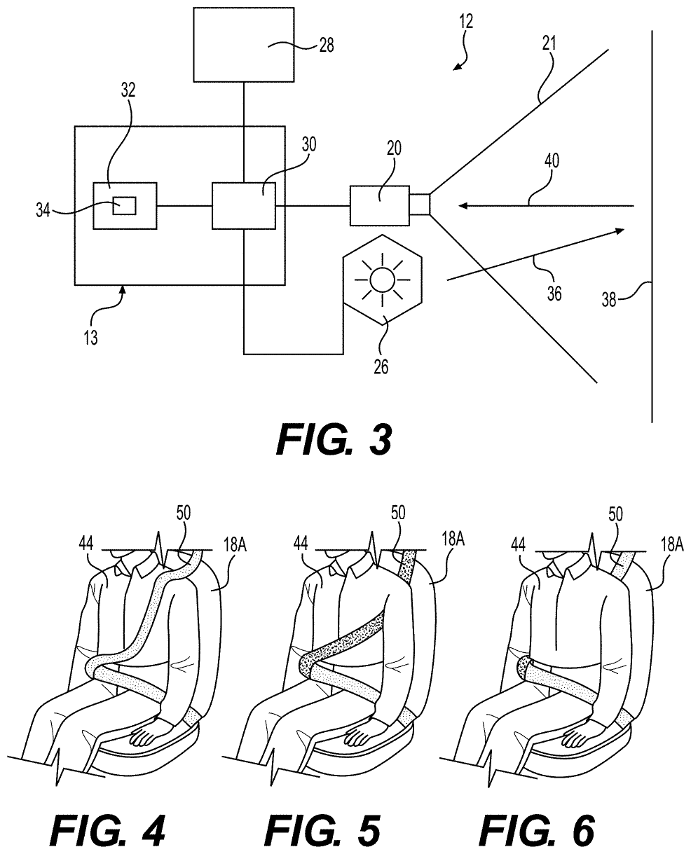

Referring to FIG. 3, a more detailed illustration of the seatbelt detection system 12 is shown. Here, the system 12 includes a control system 13 having a processor 30 in communication with a memory 32 that contains instructions 34 for executing any one of a number of different methods disclosed in this specification. The processor 30 may include a single stand-alone processor or it may include two or more processors, which may be distributed across multiple systems working together. The memory 32 may be any type of memory capable of storing digital information. For example, the memory may be solid-state memory, magnetic memory, optical memory, and the like. Additionally, it should be understood that the memory 32 may be incorporated within the processor 30 or may be separate from the processor 30 as shown.

The processor 30 may also be in communication with a camera 20. The camera 20 may be the same as cameras 20A-20F shown and described in FIG. 2. The camera 20, like the cameras 20A-20F in FIG. 2, may be a near-infrared camera. The camera 20 may include multiple physical devices, such as cameras 20A-20F illustrated in FIG. 2. The camera 20 has a field of view 21.

The near-infrared light source 26 may also be in communication with the processor 30. When activated by the processor 30, the near-infrared light source 26 projects near-infrared light 36 to an object 38 which may either absorb or reflect near-infrared light 40 towards the camera 20 wherein the camera can capture images illustrating the absorbed or reflected near-infrared light 40. These images may then be provided to the processor 30.

The processor 30 may also be in communication with the output device 28. The output device 28 may include a visual and/or audible output device capable of providing information to one or more occupants located within the cabin 14 of FIG. 2. Additionally, it should be understood that the output device 28 could be a vehicle system, such as a safety system that may take certain actions based on input received from the processor 30. For example, the processor 30 may instruct the output device 28 to limit or minimize the functions of the vehicle 10 of FIG. 1. As will be explained later in this specification, one of the functions that the seatbelt detection system 12 may perform is detecting if an occupant is properly wearing a safety belt. If the safety belt is not properly worn, the processor 30 could instruct the output device 28 to limit the functionality of the vehicle 10, such that the vehicle 10 can only travel at a greatly reduced speed.

FIG. 4 illustrates a first example of improper seatbelt positioning, showing a seatbelt 50 that is ill-adjusted on an occupant 44 sitting on a seat 18A of the vehicle 10. The ill-adjusted seatbelt 50 in this example, drapes loosely over the shoulder of the occupant 44. FIG. 5 illustrates a second example of improper seatbelt positioning, showing the seatbelt 50 passing under the armpit of the occupant 44. FIG. 6 illustrates a third example of improper seatbelt positioning, showing the seatbelt 50 passing behind the back of the occupant 44. The seatbelt detection system may detect other examples of improper seatbelt positioning, such as a seatbelt that is missing or which is not worn by the occupant 44, even in cases where the buckle is spoofed (e.g. by plugging-in the buckle with the seatbelt behind the occupant 44 or by placing a foreign object into the buckle latch).

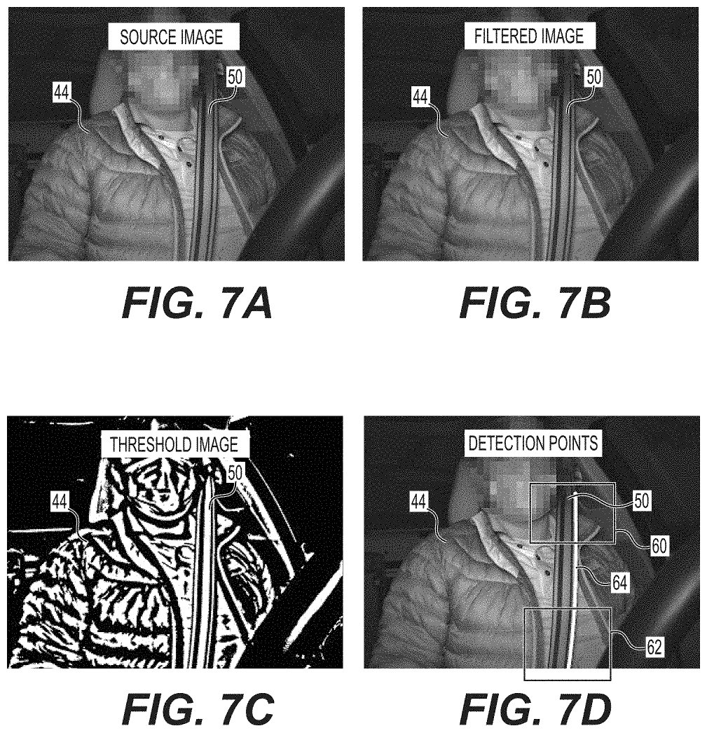

FIG. 7A shows a near infrared (NIR) image of an occupant 44 wearing a seatbelt 50 in accordance with an aspect of the present disclosure. This may represent an image captured by the camera 20 and received by the processor 30. In some embodiments, the occupant 44 may be a driver of the vehicle 10. However, the occupant 44 could also be a passenger in the vehicle 10. FIG. 7B shows a filtered image based on the NIR image of FIG. 7A; FIG. 7C shows a Black/White image based on the NIR image of FIG. 7A; and FIG. 7D shows an image based on the NIR image of FIG. 7A, illustrating detection points, in accordance with the present disclosure. Specifically, FIG. 7D shows the seatbelt 50 passing through each of a first region of interest (ROI) 60 and a second ROI 62. The first ROI 60 may be located above a shoulder of the occupant 44, and the second ROI 62 may be located below and to the left of the first ROI. The second ROI 62 may correspond to a central region of the occupant's 44 torso. The ROIs 60, 62 may each have a fixed location within the field of view 21 of the camera 20. Alternatively, the system 12 may adjust the positions of one or both of the ROIs 60, 62 based on a detected location of the occupant 44 within the field of view 21 of the camera 20.

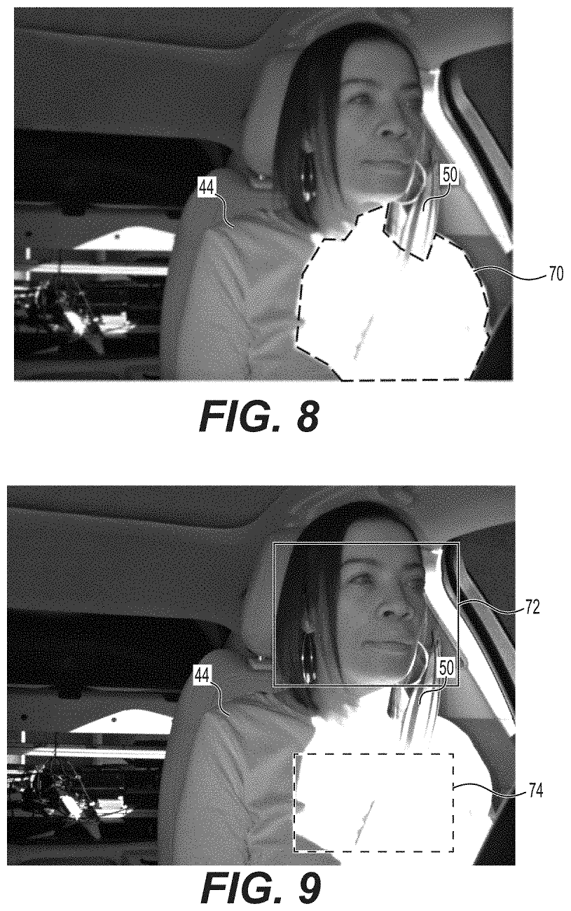

FIG. 8 shows a source image of an occupant 44 wearing a seatbelt 50, and with an oversaturated region 70. The source image may be a grayscale image. Alternatively, the source image may be a color image. The oversaturated region 70 may appear very bright and may be mostly or entirely white in a grayscale image, as shown in FIG. 8. The oversaturated region 70 may include one or more sections of the image with greater than a predetermined number of pixels each having a brightness level greater than a predetermined brightness level. For example, the image may be subdivided into some number of sections, such as a grid of the sections, with each of the sections including a same number of pixels. The oversaturated region 70 may include any number of the sections having the predetermined number of pixels with brightness levels greater than the predetermined brightness level. Alternatively or additionally, an average brightness level may be calculated for each of the sections, which may be compared with the predetermined brightness level to determine whether each of the sections corresponds to the oversaturated region 70. The image may include more than one separate oversaturated region 70.

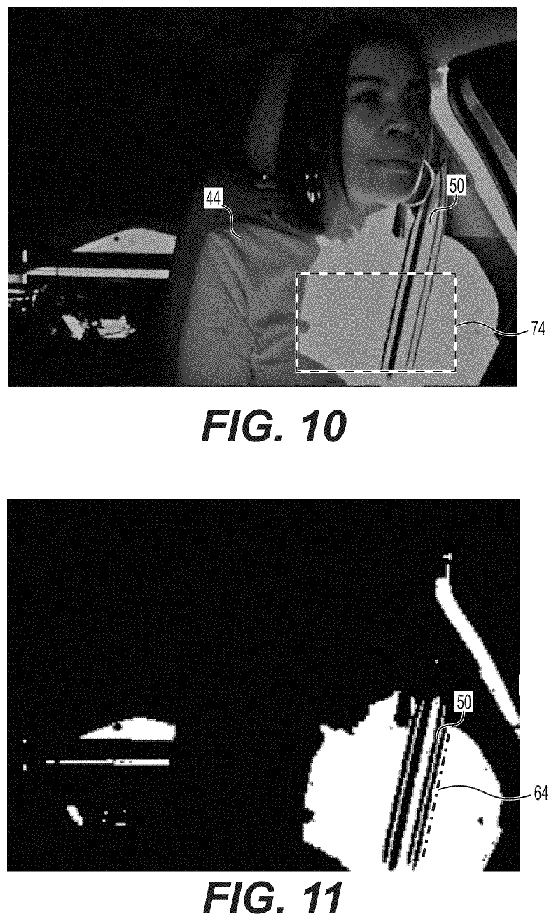

FIG. 9 shows the image of FIG. 8, with a first box 72 indicating a position of a head of the occupant 44 and a second box 74 indicating a region of interest for detecting the seatbelt 50. FIG. 10 shows an adjusted image that compensates the oversaturation condition in the region of interest for the seatbelt 50. As shown, the striped pattern of the seatbelt 50 is visible across the second box 74 in the adjusted image of FIG. 10, where the same striped pattern was not previously visible in the region of interest for detecting the seatbelt 50 in the source image shown in FIGS. 8-9. FIG. 11 shows a black-and-white image based on the adjusted image of FIG. 10. FIG. 11 shows how the position of the seatbelt 50 can be recorded as detection points 64.

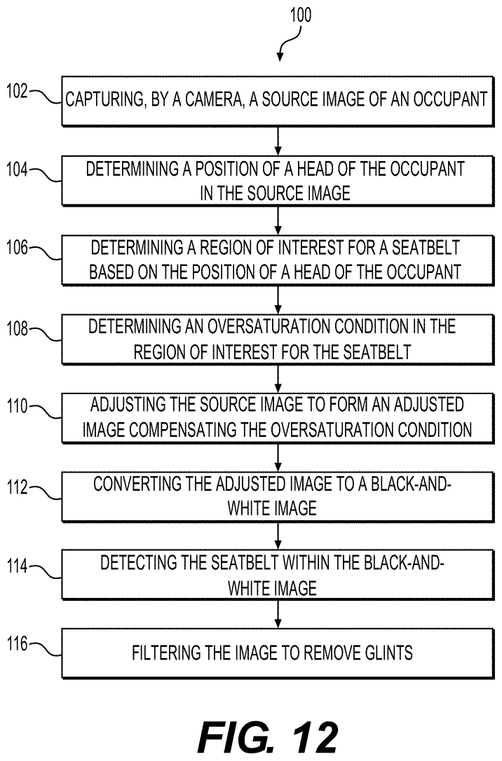

A method 100 of detecting seatbelt positioning is shown in the flowchart of FIG. 12. The method 100 includes capturing, by a camera, a source image of an occupant in a vehicle at step 102. Step 102 may include capturing the source image in the near infrared (NIR) spectrum, which may include detecting reflected NIR light provided by a near-infrared light source 26. Step 102 may further include transmitting the source image, as a video stream or as one or more still images, from the camera 20 to a control system 13 having a processor 30 for additional processing.

The method 100 also includes determining a position of a head of the occupant in the source image at step 104. The processor 30 may perform step 104, which may include using one or more face detection algorithms to detect a human face and to thereby determine the position of the head. In some embodiments, step 104 may include detecting parts of a face, such as just the eyes, which may allow the position of the head to be determined where parts of the face are obstructed, e.g. by a mask or a scarf. In some embodiments, step 104 may detect the position of the head where the occupant 44 is wearing glasses, sunglasses, a head covering, such as a hat, headband, headscarf, etc. and/or other accessories or other articles of clothing.

The method 100 also includes determining a region of interest for a seatbelt based on the position of a head of the occupant at step 106. The processor 30 may perform step 106. The region of interest for the seatbelt may be below the position of the head, for example, where the region of interest for the seatbelt is across a chest of the user. The region of interest for the seatbelt may be spaced apart from the position of the head as shown, for example, in FIG. 9. Alternatively or additionally, the region of interest for the seatbelt may include another region of the image. For example, a shoulder-crossing region of interest may be determined adjacent to the position of the head to check for a seatbelt that is positioned across the occupant's shoulder. The region of interest for the seatbelt may be different for different seating positions. For example, a region of interest for a driver-side occupant may be on a different side of the position of the head as for a front passenger occupant. This difference may correspond to the different configurations of the seatbelts for each of those seating positions.

The method 100 also includes determining an oversaturation condition in the region of interest for the seatbelt at step 108. The processor 30 may perform step 108. The oversaturation condition may include one or more parts of the region of interest for the seatbelt being oversaturated, which may be visible as a bright and/or washed-out appearance, as shown in FIGS. 8-9. In some embodiments, the oversaturation condition is determined in response to determining a predetermined number of sections of the source image each corresponding to the region of interest for the seatbelt and also being oversaturated.

In some embodiments, step 108 includes determining a predetermined number of pixels within a given region and each having a brightness level greater than a predetermined brightness level. The predetermined number of pixels may be a predetermined proportion of the pixels within the given region. For example, the image may be subdivided into some number of sections, such as a grid of the sections. The oversaturated region 70 may include any number of the sections having the predetermined number of pixels with brightness levels greater than the predetermined brightness level. Alternatively or additionally, an average or median brightness level may be calculated for each of the sections, which may be compared with the predetermined brightness level to determine whether each of the sections is oversaturated.

The method 100 also includes adjusting the source image to form an adjusted image compensating the oversaturation condition in the region of interest for the seatbelt at step 110. The processor 30 may perform step 110.

In some embodiments, adjusting the source image at step 110 includes adjusting an exposure of the source image based on a contrast ratio in the region of interest for the seatbelt. For example, the processor 30 may progressively reduce or increase an exposure value until the contrast ratio in the region of interest for the seatbelt reaches a predetermined value.

In some embodiments, adjusting the source image at step 110 includes adjusting an exposure of the source image based on causing the predetermined pattern of the seatbelt to be detected within the region of interest for the seatbelt. For example, the processor 30 may progressively reduce or increase an exposure value until the predetermined pattern of the seatbelt is detected within the region of interest for the seatbelt, or until the exposure value reaches a corresponding minimum or maximum value.

The method 100 also includes converting the adjusted image to a black-and-white (B/W) image at step 112. The terms black and white may include any representations of pixels in one of two binary states representing dark or light. The processor 30 may perform step 112, which may include using a localized binary threshold to determine whether any given pixel in the B/W image should be black or white. Such a localized binary threshold may compare a source pixel in the source image (i.e. the filtered image) to nearby pixels within a predetermined distance of the pixel. If the source pixel is brighter than an average of the nearby pixels, the corresponding pixel in the B/W image may be set to white, and if the source pixel is less bright than the average of the nearby pixels, then the corresponding pixel in the B/W image may be set to black. In some embodiments, the predetermined distance may be about 100 pixels. In some embodiments, the predetermined distance may be equal to or approximately equal to a pixel width of the seatbelt 50 with the seatbelt 50 at a nominal position relative to the camera (e.g. in use on an occupant 44 having a medium build and sitting in the seat 18a in an intermediate position.

The method 100 also includes detecting the seatbelt within the black-and-white image at step 114. The processor 30 may perform step 114. In some embodiments, step 114 includes scanning across the black-and-white image to detect a plurality of transitions between black and white segments corresponding to stripes extending lengthwise along a length of the seatbelt, and using detections of the plurality of transitions to indicate a detection of the seatbelt. For example, the processor 30 may scan across one or more lines in the B/W image to detect Black/White (or White/Black) transitions and to use detections of those transitions to indicate detections 64 of the seatbelt 50. The one or more lines may include one or more horizontal lines, although the lines may have a different orientation or direction. Step 114 may include comparing the relative distances between the transitions to detect the seatbelt by determining if those relative distances correlate to a ratio of the widths of the stripes of the seatbelt 50.

The method 100 may also include filtering the image to remove glints at step 116. Step 116 may be performed prior to determining the oversaturation condition in the region of interest for the seatbelt at step 108. The processor 30 may perform step 116, which may include applying a median filter to the image. Such a median filter may preserve edges while smoothing abnormally bright or dark areas (i.e. glints), which may result from seatbelt yarns, bad pixels in the camera 20, or other noise-inducing particles, such as lint stuck to the seatbelt 50. This step 116 may reduce a number of false detections of black/white transitions, and thereby improves the performance and reliability of the method 100.

By executing the method of the present disclosure, the seatbelt detection system 12 can determine if the occupant 44 is properly wearing their seatbelt 50. The system and method of the present disclosure can improve the confidence that the occupant 44 is properly wearing the seatbelt 50.

In addition, as stated previously, the seatbelt 50 may have light absorbing and/or reflecting material 50C located on or disposed on the seatbelt 50. The cameras 20A-20F can capture images of the material 50C. As stated before, this material 50C may be in a known pattern having pattern elements that are separated from each other by known distances 52. The seatbelt detection system 12 can then review these captured images from the camera 20A-20F and determine if the distance of the seatbelt 50 to the camera is generally an expected distance indicating that the seatbelt 50 is properly across the body 48 of the occupant 44. In addition, because this pattern is known, clothing that the occupant 44 may be wearing that may reflect and/or absorb light, such as infrared light, can be ignored as it is highly unlikely that the clothing worn by the occupant would have a pattern matching that of the pattern of the stripes 68a-68g on the seatbelt 50.

If a determination is made that the occupant 44 is properly wearing the seatbelt 50, the seatbelt detection system 12 can allow the vehicle 10 to operate in a normal mode. However, if the seatbelt detection system 12 indicates that the occupant 44 is not properly wearing the seatbelt 50, the control system 12 could take any one of a number of different actions. For example, the seatbelt detection system 12 could indicate to the occupant 44 using the output device 28 so as to provide a visual and/or audible cue that the seatbelt 50 is not being properly worn. Additionally, the output device 28 could be in communication with any one of a number of different vehicle systems so as to restrict the operation of the vehicle 10 until the seatbelt 50 is being properly worn by the occupant 44.

The seatbelt detection system 12 may also be in communication with other control systems so as to improve the reliability of the system. For example, the seatbelt detection system 12 may also be in communication with one or more sensors, such as the sensors that detect the safety belt latch 61 or tongue is inserted into the safety belt buckle 63. If the seatbelt detection system 12 determines that the safety belt buckle is properly latched and determines that the seatbelt 50 is properly positioned across the body 48 of the occupant 44, the seatbelt detection system 12 can, with more confidence, determine that the seatbelt 50 is being properly utilized by the occupant 44.

In some embodiments, dedicated hardware implementations, such as application specific integrated circuits, programmable logic arrays, and other hardware devices, can be constructed to implement one or more steps of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further, the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation, and change, without departing from the spirit of this invention, as defined in the following claims.

What is claimed is:

1. A method for detecting seatbelt positioning, comprising:
capturing, by a camera, a source image of an occupant in a vehicle;
determining a position of a head of the occupant in the source image;
determining a region of interest for a seatbelt based on the position of the head of the occupant;
determining an oversaturation condition in the region of interest for the seatbelt;
adjusting the source image to form an adjusted image compensating the oversaturation condition in the region of interest for the seatbelt;
converting the adjusted image to a black-and-white image; and
detecting the seatbelt within the black-and-white image.

2. The method of claim 1, wherein capturing the source image of the occupant includes capturing the source image in near infrared (NIR).

3. The method of claim 1, wherein adjusting the source image includes adjusting an exposure of the source image based on at least one of: a contrast ratio in the region of interest for the seatbelt, or causing a predetermined pattern of the seatbelt to be detected within the region of interest for the seatbelt.

4. The method of claim 3, wherein adjusting the source image includes adjusting the exposure of the source image based on the contrast ratio in the region of interest for the seatbelt.

5. The method of claim 3, wherein adjusting the source image includes adjusting the exposure of the source image based on causing the predetermined pattern of the seatbelt to be detected within the region of interest for the seatbelt.

6. The method of claim 1, wherein the region of interest for the seatbelt is below the position of the head of the occupant.

7. The method of claim 1, wherein determining the oversaturation condition in the region of interest for the seatbelt further includes determining a predetermined number of pixels within a given region and each having a brightness level greater than a predetermined brightness level.

8. The method of claim 1, wherein detecting the seatbelt within the black-and-white image includes scanning across the black-and-white image to detect a plurality of transitions between black and white segments corresponding to stripes extending lengthwise along a length of the seatbelt, and using detections of the plurality of transitions to indicate a detection of the seatbelt.

9. The method of claim 1, wherein converting the adjusted image to the black-and-white image includes using a binary threshold to determine whether a given pixel in the black-and-white image should be black or white based on whether a corresponding source pixel within the adjusted image is brighter than a given brightness value, wherein the given brightness value is based on an average of brightness values of pixels in the adjusted image and located within a predetermined distance of the corresponding source pixel.

10. The method of claim 1, further comprising applying a median filter to the source image to remove glints prior to determining the oversaturation condition in the region of interest for the seatbelt.

11. A system for detecting seatbelt positioning, comprising:
a seatbelt having a predetermined pattern;
a camera configured to capture a source image of an occupant wearing the seatbelt; and
a controller in communication with the camera and configured to:
determine a position of a head of the occupant in the source image;
determine a region of interest for the seatbelt based on the position of the head of the occupant;
determine an oversaturation condition in the region of interest for the seatbelt;
adjust the source image to form an adjusted image that compensates the oversaturation condition in the region of interest for the seatbelt;
convert the adjusted image to a black-and-white image; and
detect the seatbelt within the black-and-white image.

12. The system of claim 10, wherein the camera is configured to capture the source image in near infrared (NIR).

13. The system of claim 10, wherein adjusting the source image includes adjusting an exposure of the source image based on at least one of: a contrast ratio in the region of interest for the seatbelt, or causing the predetermined pattern of the seatbelt to be detected within the region of interest for the seatbelt.

14. The system of claim 13, wherein adjusting the source image includes adjusting the exposure of the source image based on the contrast ratio in the region of interest for the seatbelt.

15. The system of claim 13, wherein adjusting the source image includes adjusting the exposure of the source image based on causing the predetermined pattern of the seatbelt to be detected within the region of interest for the seatbelt.

16. The system of claim 10, wherein the region of interest for the seatbelt is below the position of the head of the occupant.

17. The system of claim 10, wherein determining the oversaturation condition in the region of interest for the seatbelt further includes determining a predetermined number of pixels within a given region and each having a brightness level greater than a predetermined brightness level.

18. The system of claim 10, wherein detecting the seatbelt within the black-and-white image includes scanning across the black-and-white image to detect a plurality of transitions between black and white segments corresponding to stripes extending lengthwise along a length of the seatbelt, and to use detections of the plurality of transitions to indicate a detection of the seatbelt.

19. The system of claim 10, wherein converting the adjusted image to the black-and-white image includes the controller determining whether a given pixel in the black-and-white image should be black or white based on whether a corresponding source pixel within the adjusted image is brighter than a given brightness value, wherein the given brightness value is based on an average of brightness values of pixels in the adjusted image and located within a predetermined distance of the corresponding source pixel.

20. The system of claim 10, further comprising the controller being configured to apply a median filter to the image of the occupant to remove glints prior to determining the oversaturation condition in the region of interest for the seatbelt.
